(19) United States
(12) Patent Application Publication
(10) Pub. No.: US 2003/0212652 A1
(43) Pub. Date: Nov. 13, 2003

(54) Max, min determination of a two-dimensional sliding window of digital data

(76) Inventor: Kevin C. Gold, Palo Alto, CA (US)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/143,610

(22) Filed: May 10, 2002

(51) Int. Cl. G06F 17/30

(52) U.S. Cl. 707/1

(57) ABSTRACT

Efficient techniques/algorithms for finding the maximum and/or minimum of a two-dimensional m×n sliding window, including a 3×3 sliding window, that take advantage of the redundant information between slides and eliminate unnecessary comparisons. The number of comparisons required are significantly reduced, making the algorithms computationally efficient.

### BACKGROUND OF THE INVENTION

1. Field of the Invention

This present invention relates to techniques or algorithms that more efficiently find a maximum and a minimum of a two-dimensional (2-D) sliding window, including a 3×3 sliding window. The techniques may be embodied in software, hardware or combination thereof and may be implemented on a computer or other processor-controlled device.

2. Description of the Related Art

Some applications in image filtering require finding the maximum and minimum values in a 2-D sliding window, that is, an m×n array of values in a digital representation. The sliding window typically starts in a corner of a rectangular representation, say the upper left corner, and moves across the representation one column at a time. In applications which require the finding of maximum and minimum values, such values are initially calculated in the first window location, and continually updated/recalculated each time the window moves. In this paradigm, between recalculations the left-most column of a matrix of values are shifted left by one column, and the right-most column receives new values.

Prior methods for finding the maximum and minimum of a 2-D sliding window either do not take full advantage of the redundant information between slides or make unnecessary comparisons. In the case of a 3×3 sliding window, which is simpler and more common than an m×n sliding window, the most naive approach requires 18 comparisons. For the m×n case, O(mn) comparisons are required. U.S. Pat. No. 6,208,764 to Archer et al. suggests a method which reduces the comparisons for the 3×3 case to an average of 12. However, in the more general m×n case, such method requires O(m²n) comparisons. In either case, the prior methods simply require too many comparisons.

### OBJECTS AND SUMMARY OF THE INVENTION

Objects of the Invention

It is therefore an object of the present invention to overcome the above-mentioned problems.

It is another object of this invention to provide a more efficient technique or algorithm for finding a maximum and a minimum of an m×n sliding window, particularly a 3×3 sliding window.

### SUMMARY OF THE INVENTION

According to one aspect of this invention, a method is provided for determining at least one of a new maximum value or a new minimum value of elements in a 3 row×3 column sliding window after the window moves from a first position one row or column to a second position. The method comprises the steps of: (a) calculating at least one of a maximum value or a minimum value among the three elements in the new row or column of the sliding window; (b) storing the maximum value or the minimum value determined in step (a); and (c) performing at least one of the following comparing steps: (c)(1) comparing the maximum value of the new row or column to the maximum value of each of the rows or columns common to the window's first and second positions to calculate the new maximum value of the sliding window, or (c)(2) comparing the minimum value of the new row or column to the minimum value of each of the rows or columns common to the window's first and second positions to calculate the new minimum value of the sliding window.

Preferably, the method determines both a new maximum value or a new minimum value of the sliding window.

Another aspect of the invention involves a method for determining at least one of a new maximum value or a new minimum value of elements in a m row×n column sliding window after the window moves from a first position one row or column to a second position. The method comprises the steps of: (a) calculating at least one of a maximum value or a minimum value among the elements of each row or column in the window's first position, and storing the determined maximum values in a maximum heap or storing the determined minimum values in a minimum heap; (b) maintaining an array of pointers to the maximum values or the minimum values stored in step (a); and (c) after sliding the window from the first position to the second position, performing the following: (1) removing the maximum value or the minimum value of the old row or column from the corresponding heap, (2) calculating at least one of a maximum value or a minimum value among the elements in the new row or column of the sliding window, (3) adding the maximum value or the minimum value determined in step (c)(2) to the corresponding maximum or minimum heap, and updating the pointer array, (4) reheapifying each heap being maintained, and (5) obtaining the value at the root of the maximum heap to determine the new maximum value of the sliding window, or obtaining the value at the root of the minimum heap to determine the new minimum value of the sliding window.

Preferably, the method determines both a new maximum value and a new minimum value of the sliding window.

In another aspect, the invention includes an apparatus for determining at least one of a new maximum value or a new minimum value of elements in a 3 row×3 column sliding window after the window moves from a first position one row or column to a second position that includes a new row or column of elements. The apparatus comprises: means for calculating at least one of a maximum value or a minimum value among the three elements in the new row or column of the sliding window; a memory for storing the maximum value or the minimum value determined in step (a); and means for comparing the maximum value of the new row or column to the maximum value of each of the rows or columns common to the window's first and second positions to calculate the new maximum value of the sliding window, or for comparing the minimum value of the new row or column to the minimum value of each of the rows or columns common to the window's first and second positions to calculate the new minimum value of the sliding window.

Yet another aspect of the invention involves an apparatus for determining at least one of a new maximum value or a new minimum value of elements in a m row×n column sliding window after the window moves from a first position one row or column to a second position. The apparatus comprises: means for calculating at least one of a maximum value or a minimum value among the elements of each row or column in the window's first position; memory for storing the determined maximum values in a maximum heap or storing the determined minimum values in a minimum heap; means for maintaining an array of pointers to the stored maximum values or the stored minimum values; and means for performing the following functions, after the window slides from the first position to the second position: (1) removing the maximum value or the minimum value of the old row or column from the corresponding heap, (2) calculating at least one of a maximum value or a minimum value among the elements in the new row or column of the sliding window, (3) adding the maximum value or the minimum value determined in (2) to the corresponding maximum or minimum heap, and updating the pointer array, (4) reheapifying each heap being maintained, and (5) obtaining the value at the root of the maximum heap to determine the new maximum value of the sliding window, or obtaining the value at the root of the minimum heap to determine the new minimum value of the sliding window.

In accordance with further aspects of the invention, any of the above-described methods or steps thereof may be implemented by a program of instructions (e.g., software) which may be stored on, or conveyed to, a computer or other processor-controlled device for execution. Alternatively, any of the methods or steps thereof may be implemented using functionally equivalent hardware (e.g., application specific integrated circuit (ASIC), digital signal processing circuitry, etc.) or a combination of software and hardware.

Other objects and attainments together with a fuller understanding of the invention will become apparent and appreciated by referring to the following description and claims taken in conjunction with the accompanying drawings.

### BRIEF DESCRIPTION OF THE DRAWINGS

In the drawings wherein like reference symbols refer to like parts:

FIG. 1 is a schematic diagram of a 3×3 window containing a set of values.

FIG. 2 is a flow chart illustrating the process of calculating the new maximum and minimum in the window after the window slides from a first position to a second position.

FIG. 3 is a flow chart illustrating the process of calculating the new maximum and minimum in an m×n window after it slides from a first position to a second position.

FIG. 4 is a block diagram illustrating an exemplary system which may be used to implement the technique of the present invention.

### DESCRIPTION OF THE PREFERRED EMBODIMENTS

A. 3×3 Sliding Window

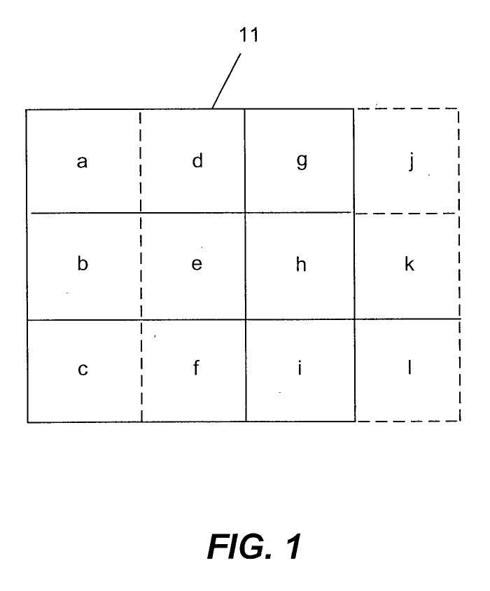

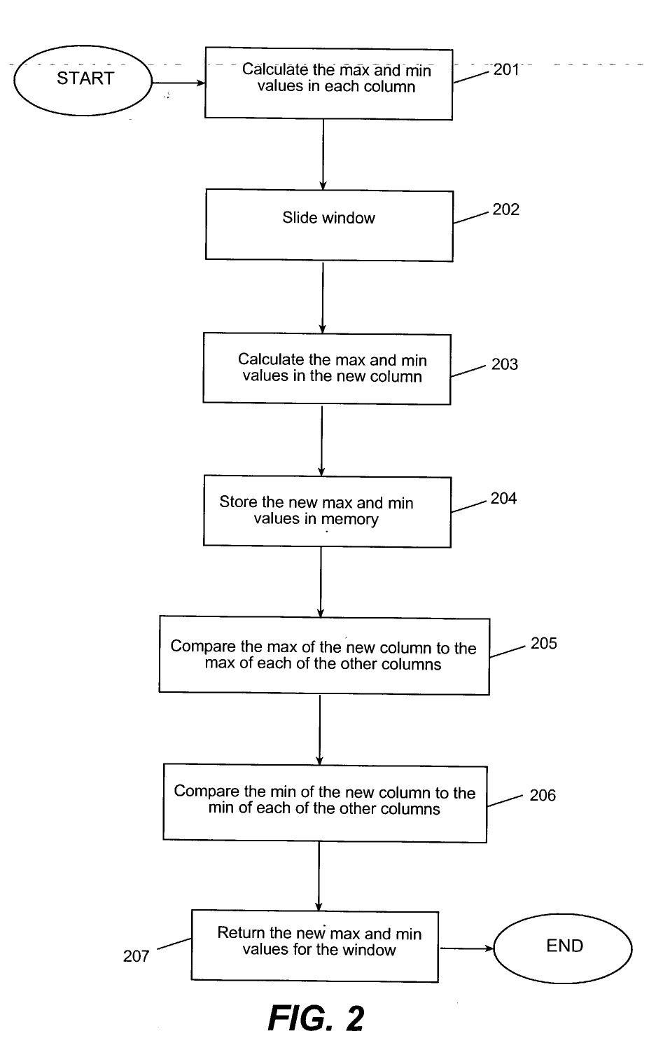

The method for calculating the new maximum and minimum in a 3×3 sliding window is described with reference to FIG. 1, which illustrates a first set of values a through i within a 3×3 matrix (e.g., window) in a first position and a second set of values d through l within the 3×3 matrix in a second position, and FIG. 2 which is a flow chart illustrating the process. The values may represent any of a number of characteristics, for example, a color or intensity value of a pixel or other digital element.

In FIG. 1, 3×3 window 11 is sliding from left to right. As the window 11 moves from the first to the second position, as shown in FIG. 1, the left-most column of values a, b and c in the window's first position are dropped, the middle and right-most columns of values in the window's first position respectively become the left-most and middle columns of values in the window's second position, and the right-most column in the window's second position receives new values j, k and l.

Although, in the illustrated embodiment, the window is sliding from left to right, the invention is not so limited. More broadly, the invention will accommodate the window sliding one column in either direction, or one row in either direction. Each of these variations will be apparent to those skilled in the art from the following description.

Before the window moves from the first position to the second position, the maximum and minimum value in each column are determined and stored in memory (step 201). After the window moves to the second position in step 202, the maximum and minimum values of the new column are determined in step 203. This can be done with three comparisons, since there are only three different comparisons possible in a set of three elements. In step 204, this maximum and minimum for the new column are then stored in memory, overwriting that portion of memory where the maximum and minimum for the oldest column was stored. Next, in step 205, the maximum value of the new column is compared to the maximums of the other two columns which were determined and stored in memory before the window moved to the second position. This takes two comparisons. Similarly, in step 206, the minimum value of the new column is compared to the minimums of the other two columns which were also determined and stored in memory before the window moved to the second position. This also takes two comparisons. From the comparisons in steps 205 and 206, the algorithm returns the new maximum and minimum values of the window in step 207. Only 7 comparisons are required for the results.

One variation of this method is to find only the new minimum or only the new maximum of the window, in which case step 207 returns only one or the other. In this case, step 203 only takes 2 comparisons, step 204 involves storage of one or the other, and either step 205 or step 206 can be omitted, for a total of 4 comparisons.

B. m×n Sliding Window

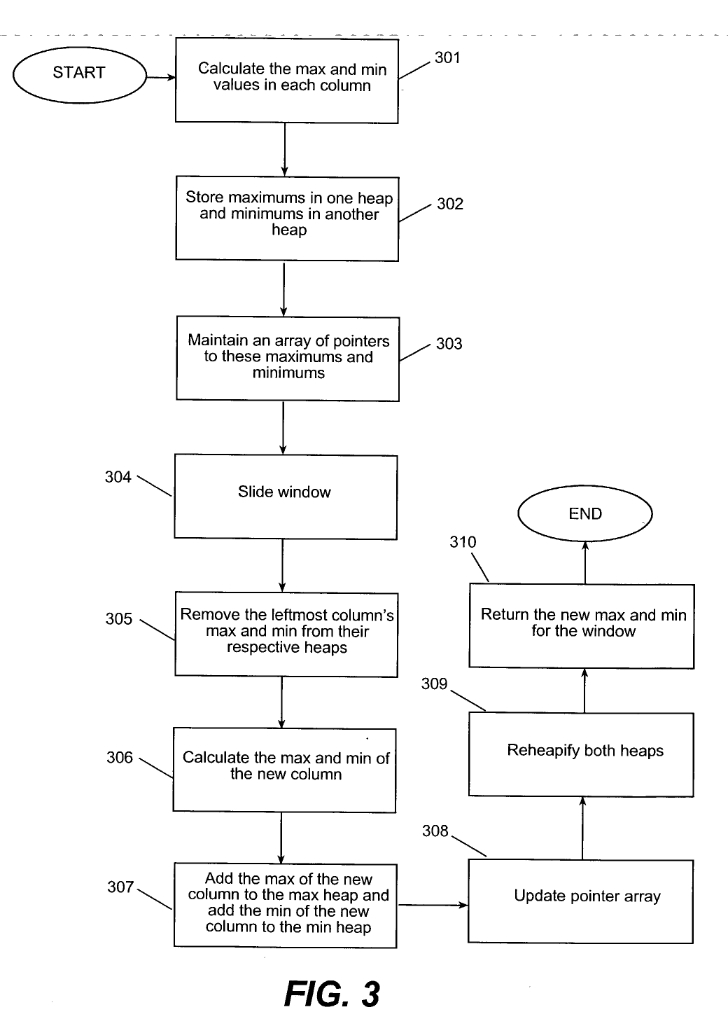

The m×n generalization of this method is described with reference to the flow chart of FIG. 3. In an initialization step 301, the maximum and minimum values of each column are determined. In step 302, the maximums are stored in one heap and the minimums in another. As is known in the art, a heap is a standard data structure for keeping track of the smallest or largest values in a collection of values. The maximum heap keeps the maximum value at the root, and the minimum heap keeps the minimum value at the root. As specified in step 303, an array of pointers to these maximums and minimums is maintained so that they can be removed easily. Conveniently, the array can be indexed by the column's true horizontal index, mod the size of the sliding window.

After sliding the window in step 304, the following steps are performed. It should be noted that, in this particular example, the window is slid one column to the right and the following steps are described within that context. Alternatively, the window may be slid to the right one column, up one row, or down one row. From the following description, the minor modifications to be made to the following steps to accommodate each of those variations will be apparent to those skilled in the art.

The leftmost column's maximum and minimum are removed from their respective heaps in step 305.

The maximum and minimum of the new column is calculated in step 306, using the standard simultaneous minimum and maximum algorithm described in the following text: Thomas Cormen, Charles E. Leiserson, and Ronald L. Rivest, Introduction to Algorithms, MIT Press, 1990. This algorithm takes values from the column in pairs and first compares them to each other. The algorithm then compares the maximum of the pair to maximum obtained so far, and also compares the pair's minimum to the current minimum. This takes 3┌n/2┐ operations.

Next, in step 307, the maximum of the new column is added to the maximum heap, and the minimum of the new column is added to the minimum heap. The pointer array is updated in step 308. Both heaps are reheapified in step 309; this is an O(log m) operation.

In step 310, the algorithm then returns the value at the root of the minimum heap as the minimum and returns the value at the root of the maximum heap as the maximum, after which the algorithm terminates.

As is the case with the 3×3 sliding window, one variation of this method is to find only the minimum or only the maximum. In this case, only one heap is maintained, and step 306 only takes n−1 comparisons. The asymptotic running time is the same.

C. Implementations

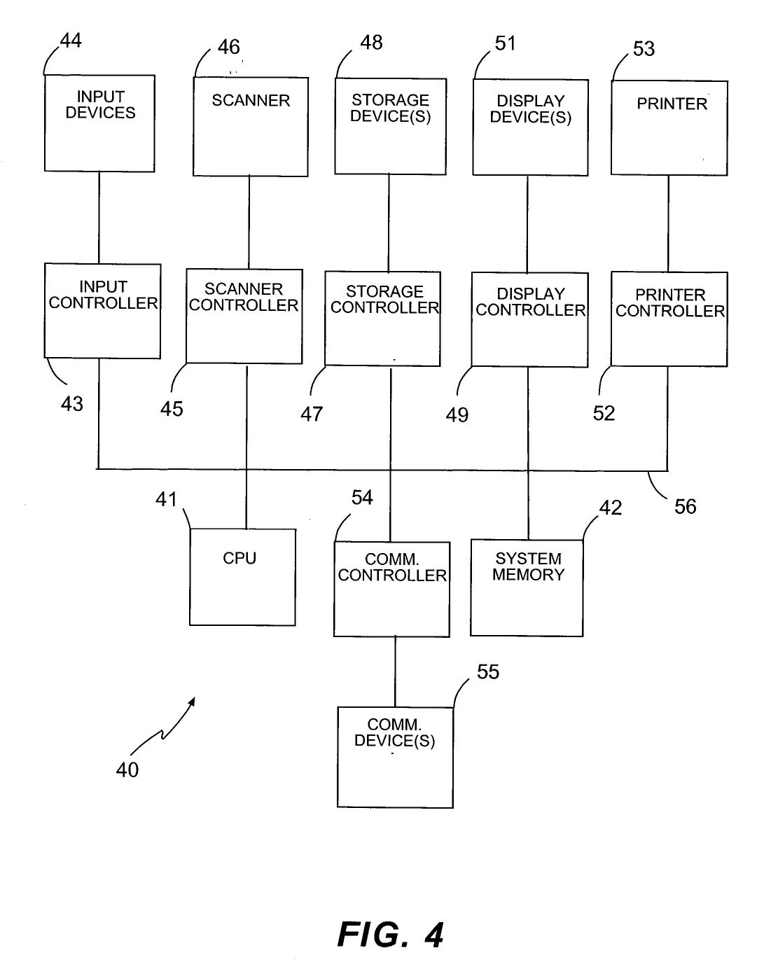

FIG. 4 illustrates an exemplary system 40 which may be used to implement the techniques of the present invention. As illustrated in FIG. 4, the system includes a central processing unit (CPU) 41 that provides computing resources and controls the computer. CPU 41 may be implemented with a microprocessor or the like, and may also include a graphics processor and/or a floating point coprocessor for mathematical computations. CPU 41 may be used as the means for performing any or all of the computational functions, e.g., calculating, determining, comparing, adding, etc. System 40 further includes system memory 42 which may be in the form of random-access memory (RAM) and read-only memory (ROM).

A number of controllers and peripheral devices are also provided, as shown in FIG. 4. Input controller 43 represents an interface to various input devices 44, such as a keyboard, mouse or stylus. There is also a controller 45 which communicates with a scanner 46 or equivalent device for digitizing documents including images or representations to be processed in accordance with the invention. A storage controller 47 interfaces with one or more storage devices 48 each of which includes a storage medium such as magnetic tape or disk, or an optical medium that may be used to record programs of instructions for operating systems, utilities and applications which may include embodiments of programs that implement various aspects of the present invention. Storage device(s) 48 may also be used to store processed or data to be processed in accordance with the invention. A display controller 49 provides an interface to a display device 51 which may be a cathode ray tube (CRT) or thin film transistor (TFT) display. A printer controller 52 is also provided for communicating with a printer 53 for printing documents including images or representations processed in accordance with the invention. A communications controller 54 interfaces with one or more communication devices 55 which enables system 40 to connect to remote devices through any of a variety of networks including the Internet, a local area network (LAN), a wide area network (WAN), or through any suitable electromagnetic carrier signals including infrared signals.

In the illustrated system, all major system components connect to bus 56 which may represent more than one physical bus. However, depending on the particular application of the invention, various system components may or may not be in physical proximity to one another. For example, the input data and/or the output data may be remotely transmitted from one physical location to another. Also, programs that implement various aspects of this invention may be accessed from a remote location (e.g., a server) over a network. Such data and/or programs may be conveyed through any of a variety of machine-readable mediums including magnetic tape or disk or optical disc, network signals, or any other suitable electromagnetic carrier signals including infrared signals.

While the present invention may be conveniently implemented with software, a hardware implementation or combined hardware/software implementation is also possible. A hardware implementation may be realized, for example, using ASIC(s), digital signal processing circuitry, or the like. As such, the term machine-readable medium further includes hardware having a program of instructions hardwired thereon. With these implementation alternatives in mind, it is to be understood that the figures and accompanying description provide the functional information one skilled in the art would require to write program code (i.e., software) or to fabricate circuits (i.e., hardware) to perform the processing required. While a CPU is convenient for performing the computational functions of the invention when implemented on a computer, other processing devices capable of carrying out the processing required may also be used in the computer environment or in other environments.

As the foregoing demonstrates, the present invention provides fast and efficient algorithms, which may be implemented with software or hardware, for determining the maximum and minimum values for a common 3×3 sliding window and more generally for an m×n sliding window. Advantageously, this invention reduces the number of comparisons required for the 3×3 case to 7 and reduces the number of comparisons required for the m×n case to O(n+log m). As a result, the operations of the algorithms of this invention are less time consuming and more memory efficient.

While the invention has been described in conjunction with several specific embodiments, further alternatives, modifications, variations and applications will be apparent to those skilled in the art in light of the foregoing description. Thus, the invention described herein is intended to embrace all such alternatives, modifications, variations and applications as may fall within the spirit and scope of the appended claims.

What is claimed is:

1. A method for determining at least one of a new maximum value or a new minimum value of elements in a 3 row×3 column sliding window after the window moves from a first position one row or column to a second position that includes a new row or column of elements, the method comprising the steps of:
(a) calculating at least one of a maximum value or a minimum value among the three elements in the new row or column of the sliding window;
(b) storing the maximum value or the minimum value determined in step (a); and
(c) performing at least one of the following comparing steps:
(c)(1) comparing the maximum value of the new row or column to the maximum value of each of the rows or columns common to the window's first and second positions to calculate the new maximum value of the sliding window, or
(c)(2) comparing the minimum value of the new row or column to the minimum value of each of the rows or columns common to the window's first and second positions to calculate the new minimum value of the sliding window.

2. The method of claim 1, wherein the storing of the maximum value or the minimum value is done by overwriting a maximum value or a minimum value of the row or column included in the window's first position but not included in the window's second position.

3. The method of claim 1, wherein the method determines both a new maximum value or a new minimum value, and
step (a) comprises calculating a maximum value and a minimum value among the three elements in the new row or column of the sliding window;
step (b) comprises storing the maximum value and the minimum value determined in step (a); and
step (c) comprises performing both step (c)(1) and step (c)(2).

4. A method for determining at least one of a new maximum value or a new minimum value of elements in a m row×n column sliding window after the window moves from a first position one row or column to a second position that includes a new row or column of elements, the method comprising the steps of:
(a) calculating at least one of a maximum value or a minimum value among the elements of each row or column in the window's first position, and storing the determined maximum values in a maximum heap or storing the determined minimum values in a minimum heap;
(b) maintaining an array of pointers to the maximum values or the minimum values stored in step (a); and
(c) after sliding the window from the first position to the second position, performing the following:
(1) removing the maximum value or the minimum value of the row or column included in the window's first position but not included in the window's second position from the corresponding heap,
(2) calculating at least one of a maximum value or a minimum value among the elements in the new row or column of the sliding window,
(3) adding the maximum value or the minimum value determined in step (c)(2) to the corresponding maximum or minimum heap, and updating the pointer array,
(4) reheapifying each heap being maintained, and
(5) obtaining the value at the root of the maximum heap to determine the new maximum value of the sliding window, or obtaining the value at the root of the minimum heap to determine the new minimum value of the sliding window.

5. The method of claim 4, wherein the method determines both a new maximum value and a new minimum value, and
step (a) comprises calculating a maximum value and a minimum value among the elements of each row or column in the window's first position, and storing the determined maximum values in a maximum heap and storing the determined minimum values in a minimum heap;
step (b) comprises maintaining an array of pointers to the maximum values and to the minimum values stored in step (a); and
step (c) comprises, after sliding the window from the first position to the second position, performing the following:
(1) removing the maximum value and the minimum value of the row or column included in the window's first position but not included in the window's second position from the corresponding heap,
(2) calculating a maximum value and a minimum value among the elements in the new row or column of the sliding window,
(3) adding the maximum value and the minimum value determined in step (c)(2) to the corresponding heap, and updating the pointer array,
(4) reheapifying both heaps, and
(5) obtaining the value at the root of the maximum heap to determine the new maximum value of the sliding window, and obtaining the value at the root of the minimum heap to determine the new minimum value of the sliding window.

6. An apparatus for determining at least one of a new maximum value or a new minimum value of elements in a 3 row×3 column sliding window after the window moves from a first position one row or column to a second position that includes a new row or column of elements, the apparatus comprising:
means for calculating at least one of a maximum value or a minimum value among the three elements in the new row or column of the sliding window;
a memory for storing the maximum value or the minimum value determined in step (a); and
means for comparing the maximum value of the new row or column to the maximum value of each of the rows or columns common to the window's first and second positions to calculate the new maximum value of the sliding window, or for comparing the minimum value of the new row or column to the minimum value of each of the rows or columns common to the window's first and second positions to calculate the new minimum value of the sliding window.

7. An apparatus for determining at least one of a new maximum value or a new minimum value of elements in a m row×n column sliding window after the window moves from a first position one row or column to a second position that includes a new row or column of elements, the apparatus comprising:
means for calculating at least one of a maximum value or a minimum value among the elements of each row or column in the window's first position;
memory for storing the determined maximum values in a maximum heap or storing the determined minimum values in a minimum heap;
means for maintaining an array of pointers to the stored maximum values or the stored minimum values; and
means for performing the following functions, after the window slides from the first position to the second position:
(1) removing the maximum value or the minimum value of the row or column included in the window's first position but not included in the window's second position from the corresponding heap,
(2) calculating at least one of a maximum value or a minimum value among the elements in the new row or column of the sliding window,
(3) adding the maximum value or the minimum value determined in (2) to the corresponding maximum or minimum heap, and updating the pointer array,
(4) reheapifying each heap being maintained, and
(5) obtaining the value at the root of the maximum heap to determine the new maximum value of the sliding window, or obtaining the value at the root of the minimum heap to determine the new minimum value of the sliding window.

8. A machine-readable medium having a program of instructions for directing a machine to determine at least one of a new maximum value or a new minimum value of elements in a 3 row×3 column sliding window after the window moves from a first position one row or column to a second position that includes a new row or column of elements, the program of instructions comprising:
(a) instructions for calculating at least one of a maximum value or a minimum value among the three elements in the new row or column of the sliding window;
(b) instructions for storing the maximum value or the minimum value determined in (a); and
(c) instructions for performing at least one of the following:
(c)(1) instructions for comparing the maximum value of the new row or column to the maximum value of each of the rows or columns common to the window's first and second positions to calculate the new maximum value of the sliding window, or
(c)(2) instructions for comparing the minimum value of the new row or column to the minimum value of each of the rows or columns common to the window's first and second positions to calculate the new minimum value of the sliding window.

9. The machine-readable medium of claim 8, wherein the instructions for storing of the maximum value or the minimum value comprises instructions for overwriting a maximum value or a minimum value of the row or column included in the window's first position but not included in the window's second position.

10. The machine-readable medium of claim 8, wherein the program of instructions comprises instructions for determining both a new maximum value and a new minimum value, and
instructions (a) comprise instructions for calculating a maximum value and a minimum value among the three elements in the new row or column of the sliding window;
instructions (b) comprise instructions for storing the maximum value and the minimum value determined in (a); and
instructions (c) comprise instructions for performing both step (c)(1) and step (c)(2).

11. A machine-readable medium having a program of instructions for directing a machine to determine at least one of a new maximum value or a new minimum value of elements in a m row×n column sliding window after the window moves from a first position one row or column to a second position that includes a new row or column of elements, the program of instructions comprising:
(a) instructions for calculating at least one of a maximum value or a minimum value among the elements of each row or column in the window's first position, and for storing the determined maximum values in a maximum heap or storing the determined minimum values in a minimum heap;
(b) instructions for maintaining an array of pointers to the maximum values or the minimum values stored in (a); and
(c) instructions for performing the following, after sliding the window from the first position to the second position:
(1) removing the maximum value or the minimum value of the row or column included in the window's first position but not included in the window's second position from the corresponding heap,
(2) calculating at least one of a maximum value or a minimum value among the elements in the new row or column of the sliding window,
(3) adding the maximum value or the minimum value determined in (c)(2) to the corresponding maximum or minimum heap, and updating the pointer array,
(4) reheapifying each heap being maintained, and
(5) obtaining the value at the root of the maximum heap to determine the new maximum value of the sliding window, or obtaining the value at the root of the minimum heap to determine the new minimum value of the sliding window.

12. The machine-readable medium of claim 11, wherein the program of instructions comprises instructions for determining both a new maximum value and a new minimum value, and
instructions (a) comprise instructions for calculating a maximum value and a minimum value among the elements of each row or column in the window's first position, and storing the determined maximum values in a maximum heap, and for storing the determined minimum values in a minimum heap;
instructions (b) comprise instructions for maintaining an array of pointers to the maximum values and to the minimum values stored in (a); and
instructions (c) comprise instructions for performing the following, after sliding the window from the first position to the second position:
(1) removing the maximum value and the minimum value of the row or column included in the window's first position but not included in the window's second position from the corresponding heap,
(2) calculating a maximum value and a minimum value among the elements in the new row or column of the sliding window,
(3) adding the maximum value and the minimum value determined in step (c)(2) to the corresponding heap, and updating the pointer array,
(4) reheapifying both heaps, and
(5) obtaining the value at the root of the maximum heap to determine the new maximum value of the sliding window, and obtaining the value at the root of the minimum heap to determine the new minimum value of the sliding window.
